(19) United States
(12) Patent Application Publication
(10) Pub. No.: US 2011/0319039 A1
(43) Pub. Date: Dec. 29, 2011

(54) RF CIRCUIT

(75) Inventors: Yukio Obuchi, Saitama-shi (JP); Yoshiaki Mayuzumi, Saitama-shi (JP)

(73) Assignee: COSMO RESEARCH CO., LTD., Saitama-shi (JP)

(21) Appl. No.: 12/822,032

(22) Filed: Jun. 23, 2010

(51) Int. Cl. H04B 1/44

(52) U.S. Cl. 455/83

(57) ABSTRACT

Demodulation/modulation circuit provides the RF circuit which had demodulation/modulation circuit working by a common component built-in at both the recovery and the modulation substantially. Demodulation/modulation circuit 15 includes at least low noise amplifier A1 and the image rejection mixer IRM and power amplifier A2 as a common component. Also, switching circuit 131,132,133,134 changing the signal paths that send out the signal paths that send out a signal from radio antenna ANT to a the physical layer circuit through demodulation/modulation circuit 15 and the signal from a the physical layer circuit to radio antenna AT through demodulation/modulation circuit 15 is comprised.

### FIELD OF THE INVENTION

The present invention relates to the RF circuit which had the demodulation/modulation circuit working by a common component built-in at both the recovery and the modulation substantially.

### BACKGROUND ART

As shown in FIG. 5, the RF circuit 81 of the communication equipment 8 used for the ITS, the iMAX, the wireless LAN are made accumulation integrally with the PHY layer circuit 82 and the The The MAC circuit 83. The RF circuit 81 has a demodulation/modulation circuit, and the PHY layer circuit 82 is the physical layer circuit, and the The The MAC circuit 83 is the media access control circuit.

For example, frequency (analog frequency) that the physical layer circuit 82 handles is 10 MHz by the ITS, the WiMAX, but it is 5 MHz in the wireless LAN. In other words the frequency which the physical layer circuit 82 handles is often different by a kind of the development. Thus, by the development of communication equipment 8 of the configuration of FIG. 5, RF circuit 81 must be designed again each time. Therefore, for development, it is not realistic from a surface of the expense to make RF circuit 81 accumulation.

Thus, as shown in FIG. 6, RF circuit 91 of the development process is formed to the board of the anomalous style with the physical layer circuit 92 of the development process and The The MAC circuit 93 in the development of the communication equipment. Note that the physical layer circuit 92 and the MAC circuit 93 is comprised to be able to cope with the frequency of the signal to receive from RF circuit 91, and a change is not required. Therefore, the physical layer circuit 92 and the MAC circuit 93 are preferable as board configuration as shown in FIG. 6. A Pan-article also made the integrated circuit as these circuits may be used. Note that computer 94 for development connected to the MAC circuit 93 are shown in FIG. 6.

Related technologies are described, for example, in JP2010-32,519.

### SUMMARY OF THE INVENTION

### Problem to be Solved by the Invention

However, as for the RF circuit 81 shown in FIG. 5, a demodulating circuit and modulation circuit are constructed separately. Thus, an occupation area of the integrated circuit is big. Thus, the price of the IC becomes higher. Also, as for the RF circuit 91 shown in FIG. 6, a demodulating circuit and modulation circuit are comprised separately. Thus, incommodiousness thereby occurs for the development. For example, the electric error by the difference of the scale often produces when a circuit developed with a board is applied to the integrated circuit. Thus, it is not easy to apply the circuit developed with a board to the integrated circuit. It becomes the problem to break off such an inconvenience conventionally. Note that the circuit which used a part of the demodulating circuit and a part of the modulation circuit in common exists conventionally, and, however, share efficiency is low, and, as shown in the patent document 1, a high effect cannot be shown.

The present invention is intended to provide the RF circuit of the low production cost in small size by comprising a demodulating circuit and modulation circuit by a common circuit. The present invention is also intended that the RF circuit which does development if easy is provided by making the RF circuit accumulation with the physical layer circuit and the MAC circuit independently.

### Means to Solve the Problem

(1) The RF circuit which had demodulation/modulation circuit a signal of the arbitrary frequency which a radio frequency band signal received by a radio antenna was reduced in arbitrary frequency, and it was output, and was input into a the physical layer circuit from the said the physical layer circuit was raised in radio frequency, and to output to the said radio antenna built-in, wherein, the said demodulation/modulation circuit at least includes the following common components, the low noise amplifier, the image rejection mixer of the subsequent stage of the said low noise amplifier, the power amplifier of the subsequent stage of the said the image rejection mixer, the switch circuits to change to the signal paths that send out the signal from the said radio antenna to the said the physical layer circuit through the said demodulation/modulation circuit, or, the signal paths that send out the signal from the said the physical layer circuit to the said radio antenna through the said demodulation/modulation circuit.

(2) The RF circuit which was described in (1) comprising the variableness gain device for a reception level adjustment provided between the said low noise amplifier and the said image rejection mixer, and, the variableness gain device for a sending level adjustment provided between the said image rejection mixer and the said power amplifier.

(3) The RF circuit as claimed in (2) or (1), wherein the RF circuit is made accumulation with the other circuit including the physical layer circuit independently. For example, the demodulation/modulation circuit can convert the radio frequency signal of the received 700 MHz band into a frequency signal of 5-20 MHz at the time of the recovery. Also, for example, the demodulation/modulation circuit can convert a frequency signal of 5-20 MHz into the radio frequency signal of the 700 MHz band in the modulation.

The said image rejection mixer can be comprised by, (a) the phase shifter which generates 2 signals with phase difference of 90 degrees from the oscillation signal of the local oscillator, (b) the branching filter that share wave does an input signal to 2 signals with phase difference of 90 degrees, (c) the first mixer multiplying one of 2 signals generated by one and the first the said phase shifter among 2 signals performed a share wave of by the said branching filter by, (d) the second mixer multiplying the other of 2 signals generated by the other and the first the said phase shifter among 2 signals performed a share wave of by the said branching filter by, (e) the synthesizer it inputs, and to add each signal from the first the said mixer and the second mixer to as a common mode. Also, the said image rejection mixer can be comprised by, (a) the phase shifter which generates 2 signals with phase difference of 90 degrees from the oscillation signal of the local oscillator, (b) the branching filter which performs a share wave of input signal to 2 signals in a same rank aspect, (c) the first mixer which multiplies one of 2 signals generated by one and the first the said phase shifter among 2 signals performed a share wave of by the said branching filter by, (d) the second mixer which multiplies the other of 2 signals generated by the other and the first the said phase shifter among 2 signals performed a share wave of by the said branching filter by, (e) a synthesizer each signal from the first the said mixer and the second mixer are input, and a 90 degrees phase shift does one input signal, and to add.

### Effect of the Invention

The RF circuit of the present invention assumed the demodulating circuit and the modulation circuit the same configuration substantially. The RF circuit can be thereby downsized. Both cases when accumulation is become on the semiconductor substrate when the RF circuit is opened in the circuit board and can smaller the occupation area of the RF circuit, and, as a result, production cost can be reduced.

The development of the RF circuit becomes easy by making the RF circuit of the present invention accumulation on the semiconductor substrate. The development of the circuit becomes easy by making the RF circuit of the present invention accumulation with a the physical layer circuit and the MAC circuit independently.

### BRIEF DESCRIPTION OF DRAWINGS

FIG. 1, in the RF circuit of the present invention, is a conceptual diagram of the principle showing the demodulation/modulation circuit which assumed a demodulating circuit and modulation circuit one circuit.

FIG. 2, with the RF circuit of FIG. 1, is the illustration shown in the close look.

FIG. 3 is a figure showing the image rejection mixer.

FIG. 4 is a circuit diagram showing one embodiment of the present invention, and the RF circuit is the block diagram showing a state connected to a the physical layer circuit and the The The MAC circuit.

FIG. 5 is the block diagram showing the conventional communication circuit.

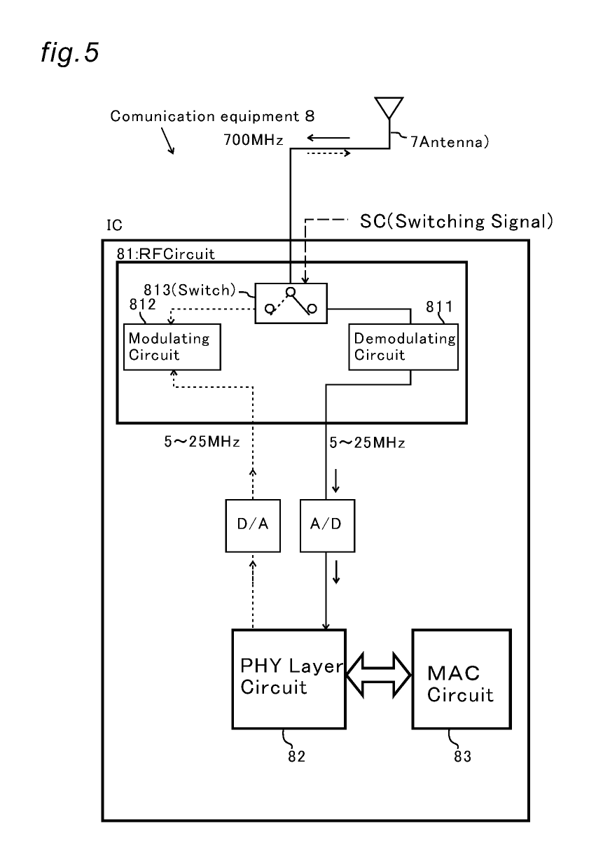

FIG. 6 is the block diagram showing the circuit for development of the conventional communication circuit.

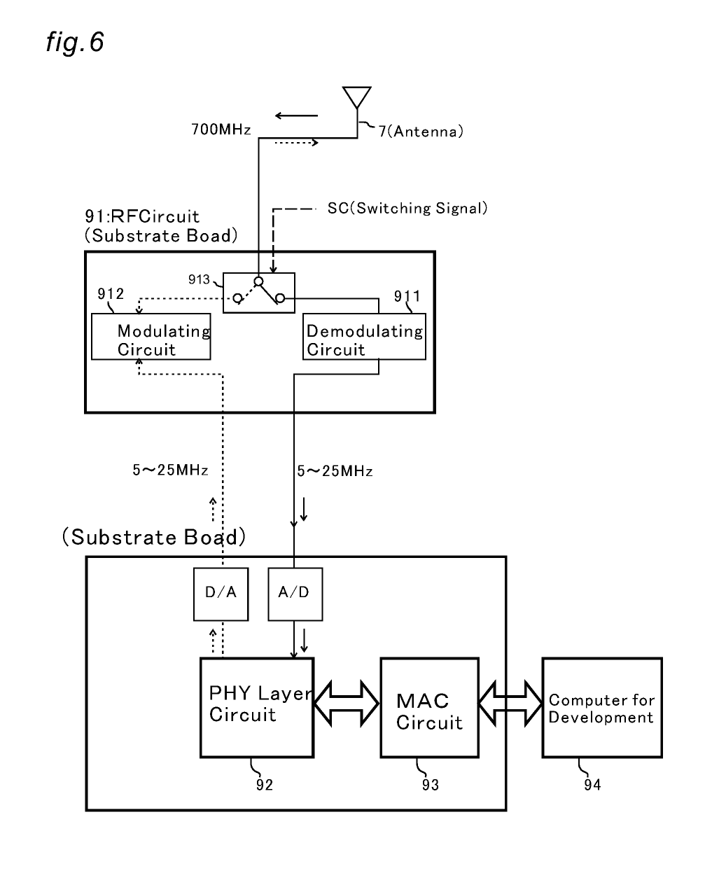

### DETAILED DESCRIPTION OF SPECIFIED EMBODIMENTS

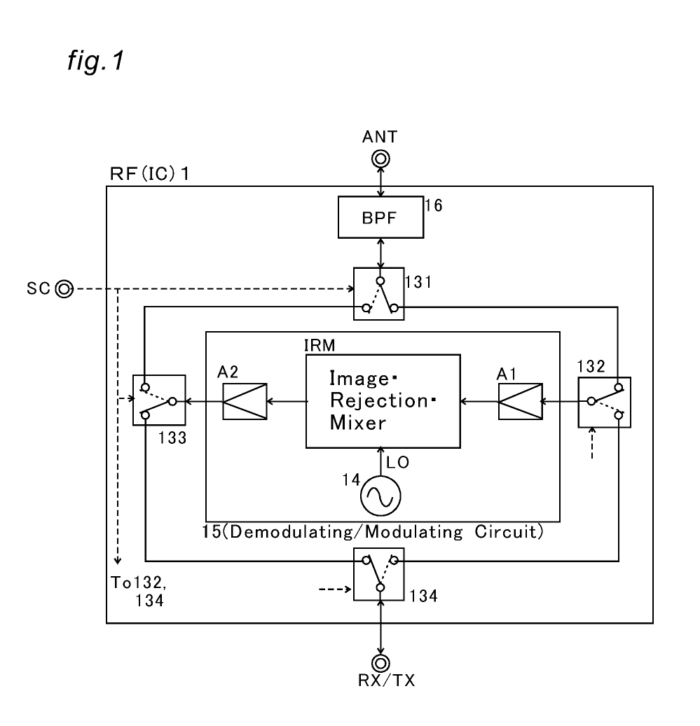

FIG. 1 is a conceptual diagram of the principle of the RF circuitry of the present invention namely the circuitry which shares the modulation circuit with the demodulating circuit. The RF circuit 1 includes working the switching circuit 131,132,133,134 and the demodulation/modulation circuit 15. The demodulation/modulation circuit 15 is comprised of the low noise amplifier A1 and the image rejection mixer IRM and the local oscillator 14 and the power amplifier A2.

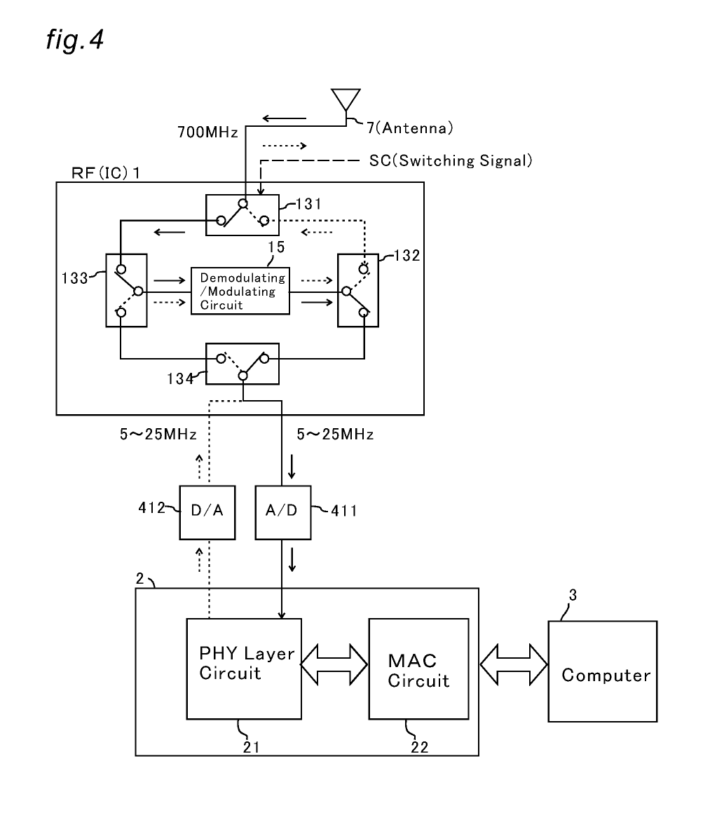

At the time of the recovery, the switching circuit 131,132,133,134 are set in the solid line side by the changeover control signal SC. The signal of the frequency 700 MHz band received by the radio antenna 7 (cf. FIG. 4) is input into the RF circuit 1 by the antenna terminal ANT. The received signal is input into the image rejection mixer IRM in this way through the BPF16, the switching circuit 131, the switching circuit 132 and the low noise amplifier A1. In the image rejection mixer IRM, the input signal is converted into a low frequency signal (5-25 MHz) using the local oscillation signal LO from the local oscillator 14. And it goes by way of the power amplifier A2, the switching circuit 133, the switching circuit 134, and this low frequency signal is sent out to the physical layer circuit 21 (cf. FIG. 4) through the A/D converter 411 (cf. FIG. 4) by the receiving/sending signal input/output terminal RX/TX.

In the modulation, the switching circuit 131,132,133,134 are set in the side as shown in the doted line by the changeover control signal SC, respectively. The sending signal (5-25 MHz) that went by way of the D/A converter 412 (cf. FIG. 4) from the physical layer circuit 21 (cf. FIG. 4) is input into the RF circuit 1 by the receiving/sending signal input/output terminal RX/TX. That is, the sending signal is input into the image rejection mixer IRM through the switching circuit 134, the switching circuit 132, the low noise amplifier A1. In the image rejection mixer IRM, an input signal is converted into a high frequency signal (the signal of the frequency 700 MHz band) using the local oscillation signal LO from the local oscillator 14. And this high frequency signal is sent out to the radio antenna 7 (cf. FIG. 4) via the power amplifier A2, the switching circuit 133, the switching circuit 131, the BPF16 by the antenna terminal ANT.

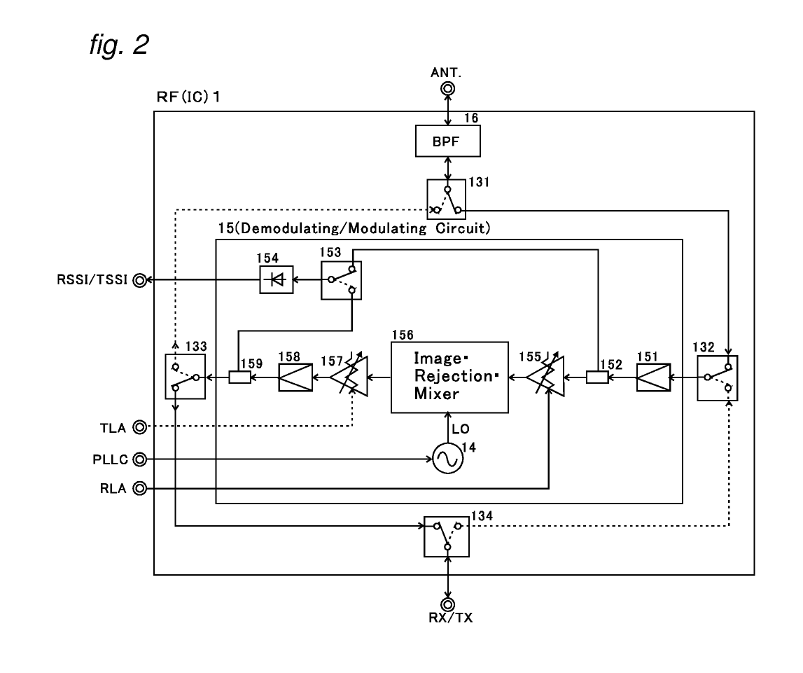

FIG. 2 is an illustration shown in the close look with RF circuit 1 of FIG. 1 more. In FIG. 2, the demodulation/modulation circuit 15 is comprised of the low noise amplifier 151, the branching filter 152, the switching circuit 153, the signal strength detector 154, the variable gain device 155, the image rejection mixer 156, the variableness gain device 157, the power amplifier 158, the branching filter 159 and the local oscillator 14.

With the demodulation/modulation circuit 15 of FIG. 2, the switching circuit 131,132,133,134 and switching circuit 153 are set at the time of the recovery in the side as shown in the solid line by the changeover control signal SC, respectively. The signal of the frequency 700 MHz band received by the radio antenna 7 (cf. FIG. 4) is input into the RF circuit 1 by the antenna terminal ANT. That is, the received signal is input into the BPF16, the switching circuit 131, the switching circuit 132, the low noise amplifier 151, the branching filter 152 and the variable gain device 155. The signal performed a share wave of by the branching filter 152 is input into the signal strength detector 154 through the switching circuit 153. The signal from the signal strength detector 154 is sent out to the control unit which is not illustrated by the receiving/sending signal intensity signals output terminal RSSI/TSSI. With this control unit, a reception level adjustment signal is generated. This reception level adjustment signal is input into a control terminal of the variable gain device 155 by the reception level adjustment signal terminal RLA, and gain of the variableness gain device 155 is adjusted.

With the image rejection mixer 156, a signal from the variable gain device 155 is converted into a low frequency signal (5-25 MHz) using the local oscillation signal LO from the local oscillator 14. And it goes by way of the variable gain device 157, the power amplifier 158, the branching filter 159, the switching circuit 133, the switching circuit 134, and this low frequency signal is sent out to the physical layer circuit 21 (cf. FIG. 4) through the A/D converter 411 (cf. FIG. 4) by receiving/sending signal input-output terminal RX/TX. Note that, in the present embodiment, indicating the signal of gain 0 db is input into a control terminal of the variable gain device 157 at the time of the recovery.

With the demodulation/modulation circuit 15 of FIG. 2, the switching circuit 131,132,133,134 and the switching circuit 153 are set in the modulation in the side as shown in the doted line by the changeover control signal SC, respectively. The sending signal (5-25 MHz) that went by way of D/A converter 412 (cf. FIG. 4) from the physical layer circuit 21 (cf. FIG. 4) is input into the RF circuit 1 by the receiving/sending signal input/output terminal RX/TX. That is, the received signal is input into the image rejection mixer 156 through the switching circuit 134, the switching circuit 132, the low noise amplifier 151, the branching filter 152 and the variable gain device 155. Note that, in the present embodiment, indicating the signal of gain 0 db is input into a control terminal of the variable gain device 155 in the modulation. With the image rejection mixer 156, an input signal is converted into a high frequency signal (the signal of the frequency 700 MHz band) using the local oscillation signal LO from the local oscillator 14. And this high frequency signal is sent out to the variable gain device 157, the power amplifier 158, the branching filter 159 and the switching circuit 133. The signal performed a share wave of by the branching filter 159 is input into the signal strength detector 154 through switching circuit 153. The signal from the signal strength detector 154 is sent out to the control unit which is not illustrated by the receiving/sending signal intensity signals output terminal RSSI/TSSI. With this control unit, a sending level adjustment signal is generated. This sending the level adjustment signal is input into a control terminal of the variable gain device 157 by sending level adjustment signal terminal TLA, and gain of the variableness gain device 157 is adjusted. And the sending signal from the switching circuit 133 is sent out to the radio antenna 17 (cf. FIG. 4) through the switching circuit 131, the BPF16 by the antenna terminal ANT.

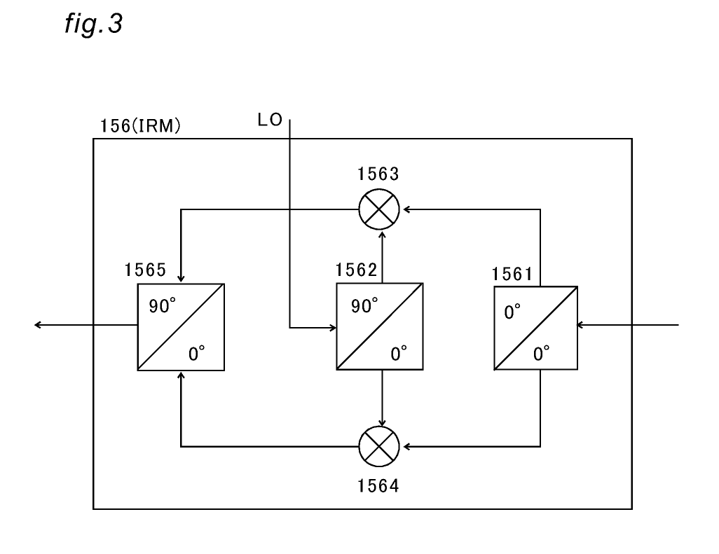

The image rejection mixer 116 becomes the branching filter 1161 and the phase shifter 1162 from the mixer 1163, 1164 and the synthesizer 1165 as shown in FIG. 3. As for the branching filter 1161, share wave does input signal to two signals of the common mode, and it is sent out to the mixer 1163, 1164. The signal from the local oscillator 14 is input into the phase shifter 1162, and the phase shifter 1162 outputs two signals that phase shifts are different 90 degrees to the mixer 1163, 1164. Herein, the mixer 1163 mixes the signal of the 90 degrees phase shift from the phase shifter 1162 with a signal from the branching filter 1161, and it is sent to the synthesizer 1165. The mixer 1164 mixes the signal of the 0 degrees phase shift from the phase shifter 1162 with a signal from the branching filter 1161, and it is sent to the synthesizer 1165. The signal which made a signal from the mixer 1164 make 90 degrees phase shift with the synthesizer 1165 and the signal from the mixer 1164 are synthesized, and it is output to the power amplifier 117.

FIG. 4 is an illustration showing the other embodiments of the RF circuit of the present invention. In FIG. 4, the RF circuit 1 comprises the demodulating circuit 11, the modulation circuit 12 and the switching circuit 13. The RF circuit 1 is connected to the circuit 2 comprising the physical layer circuit 21 and the MAC circuit 22, and the circuit 2 is connected to the computer 3.

The demodulating circuit 11 reduces a radio frequency band signal (here a signal of 715M-725 MHz) received by the radio antenna 7 in arbitrary frequency (from 5 MHz 20 MHz), and it is output to the physical layer circuit 21. The modulation circuit 12 raises a signal of arbitrary frequency (from 5 MHz 20 MHz) input from the physical layer circuit 21 in radio frequency (a signal of 715M-725 MHz), and it is output to the radio antenna 7.

The physical layer circuit 21 is typically the interface circuit. In this embodiment, the A/D converter 411, the D/A converter 412 are comprised between the physical layer circuit 21 and the RF circuit 1. The A/D converter 411, the D/A converter 412 can be made for the physical layer circuit 21, and it can be made for the RF circuit 1. The physical layer circuit 21 is connected to the MAC circuit 22, and the signal from the demodulating circuit 11 is handed to the MAC circuit 22, and the signal from the MAC circuit 22 is handed to the modulation circuit 12. The radio antenna 7 is connected to the demodulating circuit 11 and the modulation circuit 12 through switching the circuit 13. The switching circuit 13 can change the radio antenna 7 to the demodulating circuit 11 and either of the modulation circuit 12 by the changeover signal SC from the outside.

In the attached drawings, the following reference numerals correspond to:

1 RF circuit

2 the physical layer circuit

3 computers

7, 17 radio antennas

8 communication equipment

11 demodulating circuits

12 modulation circuit

13,131,132,133,134,153 14 switching circuit local oscillators 15 return modulation circuit

16BPF

21 the physical layer circuits

22The The MAC circuit

116,156 IRM image rejection mixer

117,158, A2 power amplifier

151, A1 low noise amplifier

152, 159, 1161 branching filters

154 signal strength detectors

155,157 variableness gain device

412D/A converter

411A/D converter

1162 phase shifters

1163, 1164 mixers

1165 synthesizers

ANT antenna terminal

An IC occupation area

LAN radio

An LO local oscillation signal

RLA reception level adjustment signal terminal

An SC changeover control signal

A TLA sending level adjustment signal terminal

I claim:

1. The RF circuit which had demodulation/modulation circuit a signal of the arbitrary frequency which a radio frequency band signal received by a radio antenna was reduced in arbitrary frequency, and it was output, and was input into a the physical layer circuit from the said the physical layer circuit was raised in radio frequency, and to output to the said radio antenna built-in, wherein,
the said demodulation/modulation circuit at least includes the following common components,
the low noise amplifier,
the image rejection mixer of the subsequent stage of the said low noise amplifier,
the power amplifier of the subsequent stage of the said the image rejection mixer,
the switch circuits to change to
the signal paths that send out the signal from the said radio antenna to the said the physical layer circuit through the said demodulation/modulation circuit, or,
the signal paths that send out the signal from the said the physical layer circuit to the said radio antenna through the said demodulation/modulation circuit.

2. The RF circuit which was described in claim 1 comprising the variableness gain device for a reception level adjustment provided between the said low noise amplifier and the said image rejection mixer, and, the variableness gain device for a sending level adjustment provided between the said image rejection mixer and the said power amplifier.

3. The RF circuit as claimed in claim 1, wherein the RF circuit is made accumulation with the other circuit including the physical layer circuit independently. For example, the demodulation/modulation circuit can convert the radio frequency signal of the received 700 MHz band into a frequency signal of 5-20 MHz at the time of the recovery. Also, for example, the demodulation/modulation circuit can convert a frequency signal of 5-20 MHz into the radio frequency signal of the 700 MHz band in the modulation.

4. The RF circuit as claimed in claim 2, wherein the RF circuit is made accumulation with the other circuit including the physical layer circuit independently. For example, the demodulation/modulation circuit can convert the radio frequency signal of the received 700 MHz band into a frequency signal of 5-20 MHz at the time of the recovery. Also, for example, the demodulation/modulation circuit can convert a frequency signal of 5-20 MHz into the radio frequency signal of the 700 MHz band in the modulation.
